(19) United States
(12) Patent Application Publication
(10) Pub. No.: US 2012/0105187 A1
(43) Pub. Date: May 3, 2012

(54) Inductor Device

(75) Inventor: Huo-Li LIN, Taipei County (TW)

(73) Assignee: TRIO TECHNOLOGY CO., LTD., TAIPEI CITY (TW)

(21) Appl. No.: 13/007,680

(22) Filed: Jan. 17, 2011

(30) Foreign Application Priority Data
Nov. 2, 2010 (TW) 099137653

(51) Int. Cl. H01F 27/02

(52) U.S. Cl. 336/90

(57) ABSTRACT

An inductor device includes a coil, two conductive bases and a shell. The coil is located over and coupled with the two conductive bases. The shell covers the coil and exposes partial conductor bases. The shell is made by an alloy material consisting of Fe, Cr, Si, Mn, S, C, P and Al. The weight ratio of Cr is 10.5%˜13.5%, Si is 0.1%˜0.5%, Mn is 0.1%˜1.0%, S is 0.01%˜0.053%, C is 0.01%˜0.05%, P is 0.01%˜0.05% and Al is 0.1%˜1.0%.

### RELATED APPLICATIONS

This application claims priority to Taiwan Application Serial Number 099137653, filed Nov. 2, 2010, which is herein incorporated by reference.

### FIELD OF INVENTION

The present invention relates to an inductor device. More particularly, the present invention relates to an inductor device formed by pre-alloyed powder.

### DESCRIPTION OF RELATED ART

An inductor or a reactor is a passive electrical component that can store energy in a magnetic field created by the electric current passing through it. An inductor's ability to store magnetic energy is measured by its inductance, in units of henries.

Typically, an inductor is constructed as a coil of conducting material, typically copper wire, wrapped around a core either of air or of ferromagnetic material. Core materials with a higher permeability than air increase the magnetic field and confine it closely to the inductor, thereby increasing the inductance. For example, Ferromagnetic-core or iron-core inductors use a magnetic core made of a ferromagnetic material such as iron or ferrite to increase the inductance. The coil and the core are packaged in a shell to form an inductor device.

However, the shell of the typical inductor is formed by a single material. It is very difficult to add different material to improve the characteristic of the shell.

### SUMMARY

This present invention provides an inductor device with a shell formed by pre-alloyed powder.

The present invention provides an inductor device includes a coil, two conductor bases and a shell. The coil is located over and coupled with the two conductor bases. The shell covers the coil and exposes partial conductor bases. The shell is made by the material consisted of Fe, Cr, Si, Mn, S, C, P and Al. The weight ratio of Cr is 10.5%˜13.5%, Si is 0.1%˜0.5%, Mn is 0.1%˜1.0%, S is 0.01%˜0.053%, C is 0.01%˜0.05%, P is 0.01%˜0.05% and Al is 0.1%˜1.0%.

In an embodiment, the coil is constructed by a conductive line wrapped around an axle.

In an embodiment, a powder metallurgy process is used to mix a plurality of pre-alloyed metal powder to form the alloy material.

In an embodiment, the pre-alloyed metal powders are produced by gas, water and air atomization.

In an embodiment, each conductive base further comprise one extended part, when the coil is covered by the shell, the extended part extends out the shell and is bent up or down to fix the conductive bases with the shell.

In an embodiment, each conductive base further comprises one coupling position for receiving a corresponding end of the coil.

Accordingly, the shell of the inductor device in the present invention is made by a typical powder metallurgy process to mix different pre-alloyed metal powders. By mixing different material to form the shell can improve the characteristic of the shell.

### BRIEF DESCRIPTION OF THE DRAWINGS

The invention can be more fully understood by reading the following detailed description of the embodiments, with reference made to the accompanying drawings as follows:

FIG. 1A illustrates a schematic diagram of a coil according to an embodiment of the present invention.

FIG. 1B illustrates a schematic diagram of a conductor base according to an embodiment of the present invention.

FIG. 1C illustrates a schematic diagram of a coil located over conductor base according to an embodiment of the present invention.

FIG. 1D illustrates a schematic diagram of an inductor device according to an embodiment of the present invention.

FIG. 1E illustrates a schematic diagram of mass production structure for the inductor device according to an embodiment of the present invention.

FIG. 1F illustrates a schematic diagram of mass production structure for the inductor device according to another embodiment of the present invention.

FIG. 2A illustrates a schematic diagram of a conductor base according to another embodiment of the present invention.

FIG. 2B illustrates a schematic diagram of a coil located over conductor base according to another embodiment of the present invention.

FIG. 2C illustrates a schematic diagram of an inductor device according to another embodiment of the present invention.

FIG. 3 illustrates a schematic diagram of an SMD inductor device according to an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

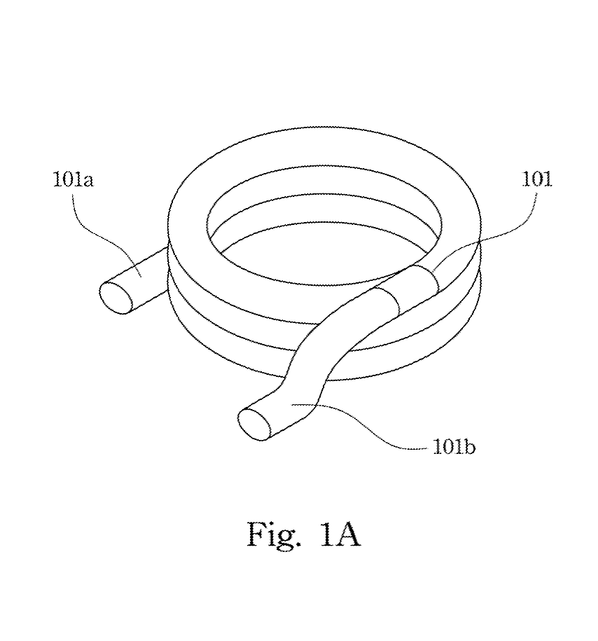

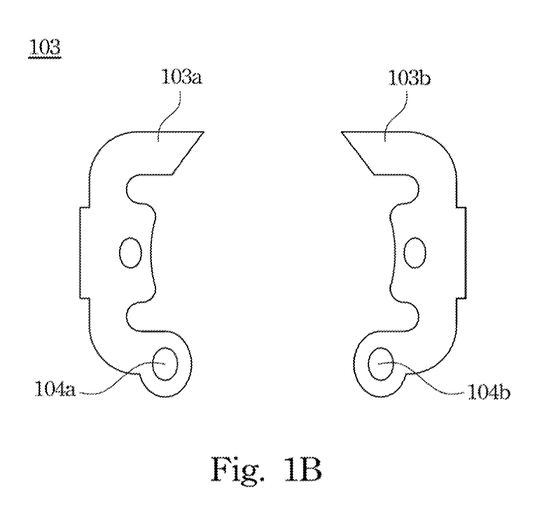

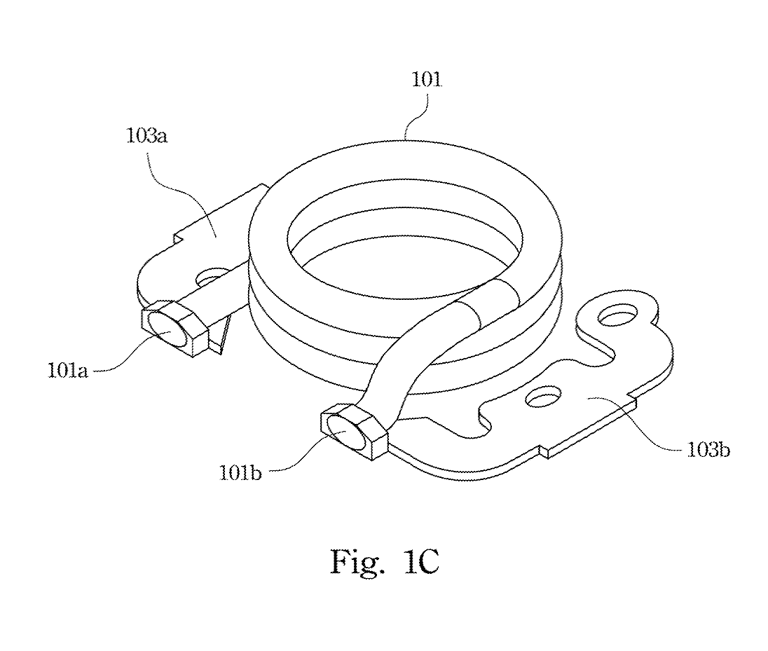

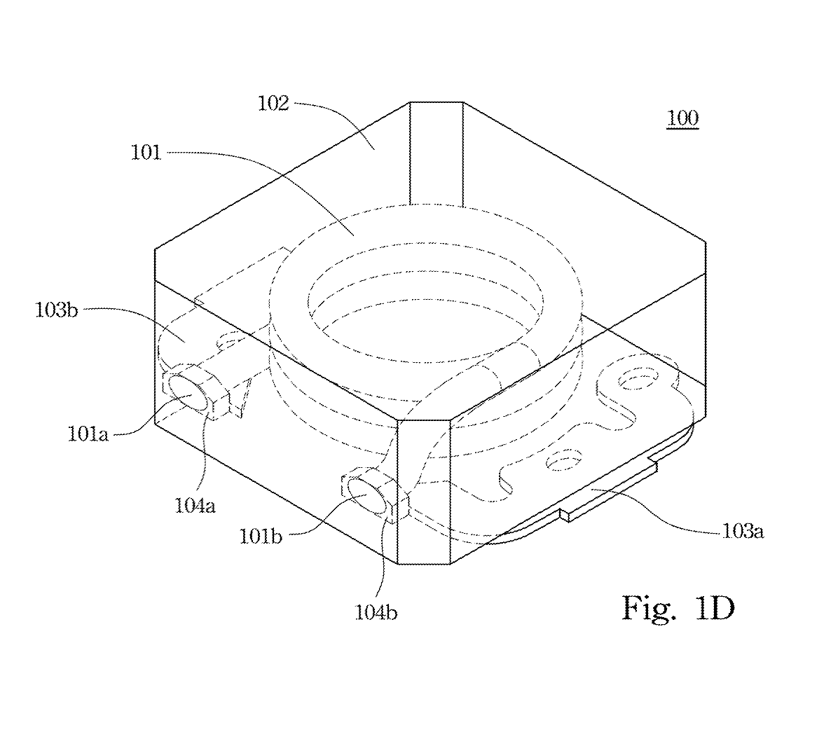

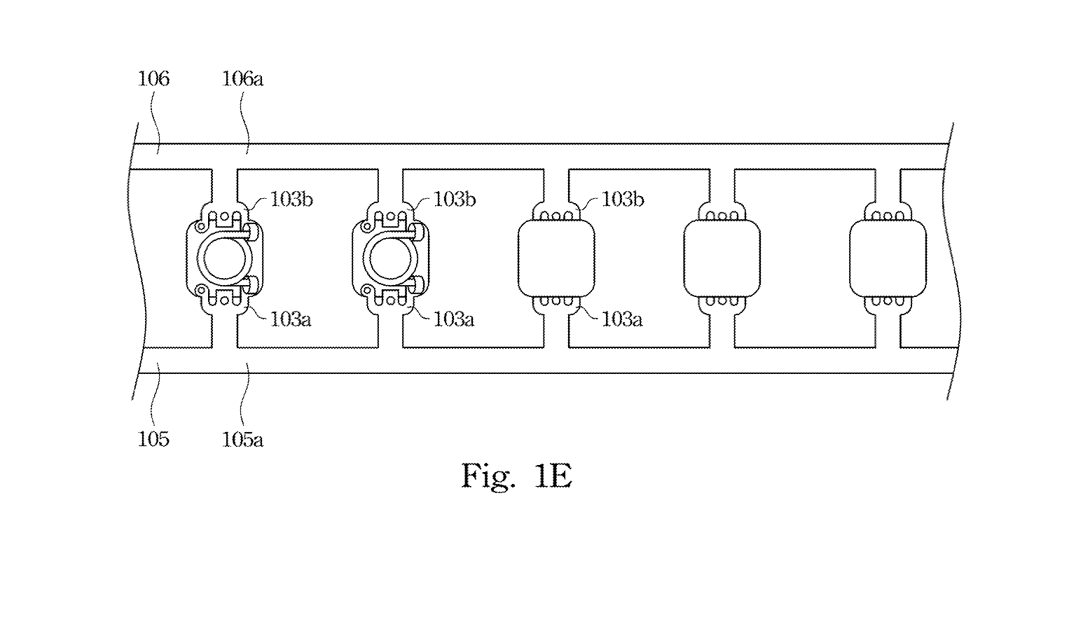

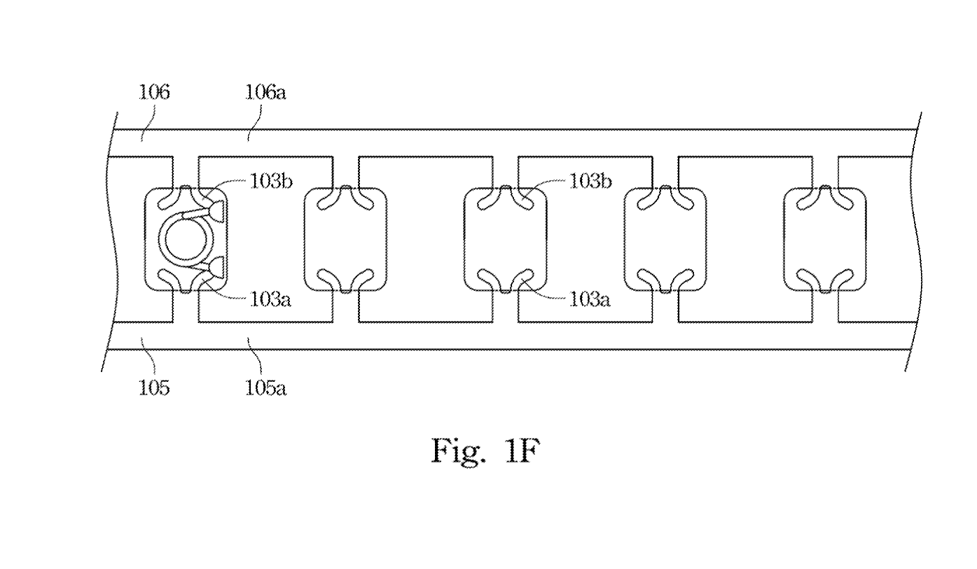

FIG. 1A illustrates a schematic diagram of a coil of an inductor. FIG. 1B illustrates a schematic diagram of a conductor base for locating a coil of an inductor. FIG. 1C illustrates a schematic diagram of a coil located over conductor base. FIG. 1D illustrates a schematic diagram of an inductor device. Please refer to FIG. 1A˜FIG. 1D.

The inductor device 100 includes a coil 101, a base 103 and a shell 102 covering the coil 101 and partial of the base 103. The coil 101 is constructed by a conductive line wrapped around an axle. An insulation layer formed in the surface of the conductive line. The two ends 101a and 101b of the coil 101 extends toward a same direction. The base 103 includes two conductive bases 103a and 103b. The conductive base 103a has a coupling position 104a for receiving the end 101a of the coil 101 when the coil 101 is located on the base 103. The conductive base 103b has a coupling position 104b for receiving the ends 101b of the coil 101 when the coil 101 is located on the base 103.

The coil 101 is covered by shell 102. A molding method, such as the compression molding method, is used to form the shell 102. Partial conductive base 103a and partial conductive base 103b are exposed out the shell 102 to form two connecting points. The coil 101 can electrically connect with other circuits through the two connecting points.

A typical powder metallurgy process is used to mix the pre-alloyed metal powder to form the shell 102. The pre-alloyed metal powders are produced by gas, water and air atomization. Atomization is accomplished by forcing a melt metal stream through an orifice at moderate pressures. A gas is introduced into the metal stream just before it leaves the nozzle, serving to create turbulence as the entrained gas expands (due to heating) and exits into a large collection volume exterior to the orifice. The collection volume is filled with gas to promote further turbulence of the melt metal jet. Air and powder streams are segregated using gravity or cyclonic separation. In an embodiment, the metal is melt at 1600° C.˜1700° C.

Powder metallurgy is a forming and fabrication technique consisting of three major processing stages. First, the primary material is physically powdered, divided into many small individual particles. Next, the powder is injected into a mold or passed through a die to produce a weakly cohesive structure (via cold welding) very near the dimensions of the object ultimately to be manufactured. Pressures of 10-50 tons per square inch are commonly used. Also, to attain the same compression ratio across more complex pieces, it is often necessary to use lower punches as well as an upper punch. Finally, the end part is formed by applying pressure, high temperature, long setting times (during which self-welding occurs), or any combination thereof. In an embodiment, the material for forming the shell 102 includes Fe, Cr, Si, Mn, S, C, P and Al. By mixing different material can improve the characteristic of the shell 102. For example, the material of Mn and Al can improve the function for storing energy of the inductor device. The material of Cr can prevent the shell 102 being oxidized. The material of Si can improve the insulating function of the shell 102. Moreover, using pre-alloyed metal powder to form the shell 102 can make an average distribution for the material. In an embodiment, the weight ratio of Cr is 10.5%˜13.5%, Si is 0.1%˜0.5%, Mn is 0.1%˜1.0%, S is 0.01%˜0.053%, C is 0.01%˜0.05%, P is 0.01%˜0.05% and Al is 0.1%˜1.0%.

FIG. 1E illustrates a schematic diagram of mass production for the inductor device according to an embodiment of the present invention. The conductive bases 103a couples with a trunk 105a to form a comb structure 105. The conductive bases 103b couples with a trunk 106a to form a comb structure 106. The comb structure 105 faces the comb structure 106. Each coil 101 is located on corresponding conductive bases 103a and 103b. A shell 102 formed by the above materials is formed on the coil 101. Then, the conductive bases 103a are separated from the trunk 105a and the conductive bases 103b are separated from the trunk 106a. Accordingly, a plurality of inductor device is formed. In another embodiment, each conductive bases 103a and 103b has an appearance of “Y”. Each coil 101 is located on corresponding conductive bases 103a and 103b.

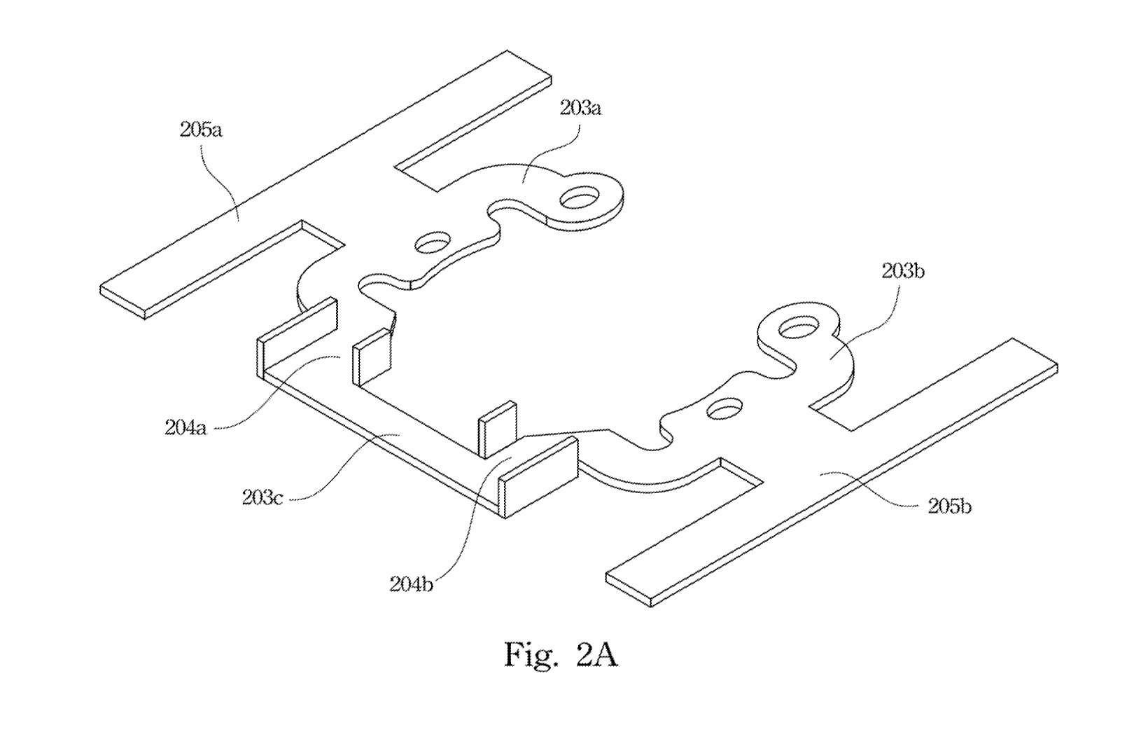

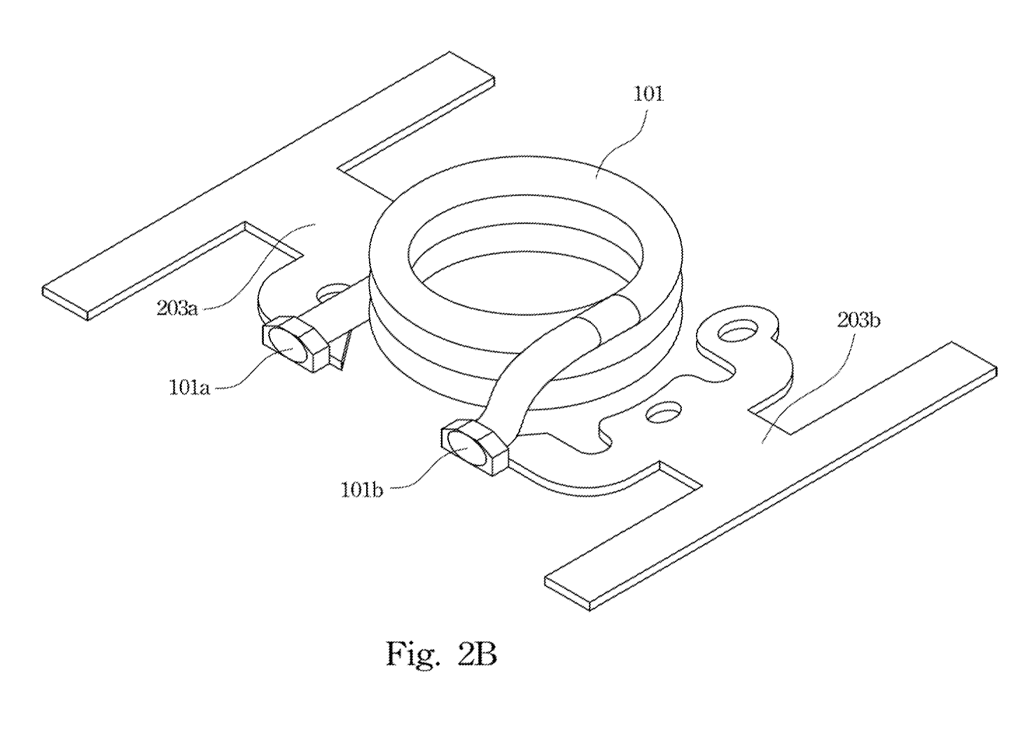

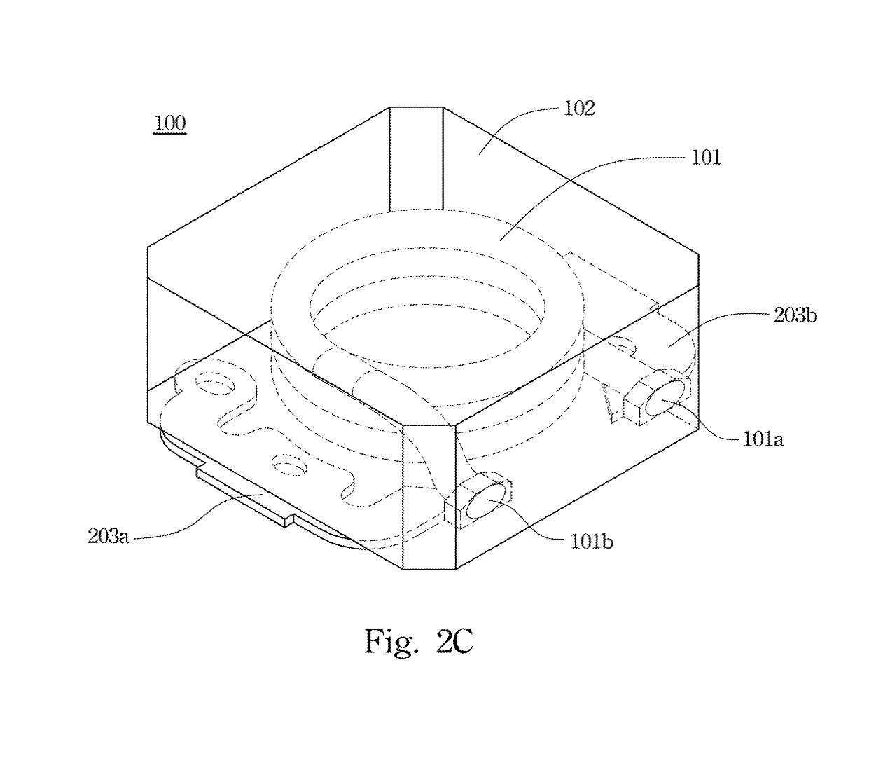

FIG. 2A illustrates a schematic diagram of a conductor base according to another embodiment. FIG. 2B illustrates a schematic diagram of a coil located over the conductor base. FIG. 2C illustrates a schematic diagram of an inductor device. Please refer to FIG. 1A, and FIGS. 2A, 2B and 2C.

The base 203 includes two conductive bases 203a and 203b. A connection part 203c connects the two conductive bases 203a and 203b. The connection part 203c can position the two ends 101a and 101b of the coil 101 on the two conductive bases 203a and 203b. That is, after the coil 101 is located over the base 203, the connection part 203c is removed. Moreover, the conductive base 203a has a coupling position 204a for receiving the end 101a of the coil 101 when the coil 101 is located on the base 203. The conductive base 203b has a coupling position 204b for receiving the ends 101b of the coil 101 when the coil 101 is located on the base 203. In this embodiment, the conductive bases 203a and 203b further comprise extended parts 205a and 205b respectively. When the coil 101 is covered by shell 102 by a molding method, the extended parts 205a and 205b are extended out the shell 102 and are bent up or down to fix the bases 203a and 203b with the shell 102. The exposed part of the extended parts 205a and 205b form two connecting points. The coil 101 can electrically connect with other circuits through the two connecting points. In an embodiment, the material for forming the shell 102 includes Fe, Cr, Si, Mn, S, C, P and Al. The weight ratio of Cr is 10.5%˜13.5%, Si is 0.1%˜0.5%, Mn is 0.1%˜1.0%, S is 0.01%˜0.053%, C is 0.01%˜0.05%, P is 0.01%˜0.05% and Al is 0.1%˜1.0%.

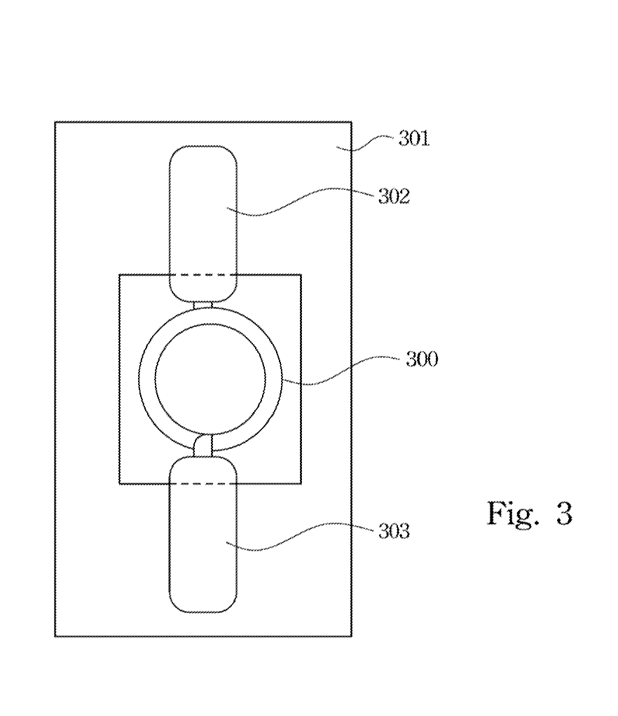

FIG. 3 illustrates a schematic diagram of an SMD inductor device according to another embodiment of the present invention. Surface mount technology (SMT) is a method for constructing electronic circuits in which the components, such resistor, capacitor, transistor, or Surface Mounted Components, are mounted directly onto the surface of printed circuit boards (PCBs). Electronic devices so made are called surface mount devices or SMDs. In an embodiment, the Surface mount technology is used to fabricate the inductor device 300 to the surface of printed circuit boards (PCBs) 301. The solders 302 and 303 connected the inductor device 300 to the surface of printed circuit boards (PCBs) 301.

Accordingly, the shell of the inductor device in the present invention is made by a typical powder metallurgy process to mix different pre-alloyed metal powders. By mixing different material to form the shell can improve the characteristic of the shell. For example, the material of Mn and Al can improve the function for storing energy of the inductor device. The material of Cr can prevent the shell being oxidized. The material of Si can improve the insulating function of the shell.

Although the present invention has been described in considerable detail with reference to certain embodiments thereof, other embodiments are possible. Therefore, it will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An inductor device, comprising:
a coil;
two conductive bases, wherein the coil is located over and coupled with the two conductor bases; and
a shell, wherein the shell covers the coil and exposes partial conductor bases, and the shell is made by a alloy material consisting of Fe, Cr, Si, Mn, S, C, P and Al, the weight ratio of Cr is 10.5%˜13.5%, Si is 0.1%˜0.5%, Mn is 0.1%˜1.0%, S is 0.01%˜0.053%, C is 0.01%˜0.05%, P is 0.01%˜0.05% and Al is 0.1%˜1.0%.

2. The inductor device of claim 1, wherein the coil is constructed by a conductive line wrapped around an axle.

3. The inductor device of claim 1, wherein a powder metallurgy process is used to mix a plurality of pre-alloyed metal powder to form the alloy material.

4. The inductor device of claim 3, wherein the pre-alloyed metal powders are produced by gas, water and air atomization.

5. The inductor device of claim 1, wherein each conductive base further comprise one extended part, when the coil is covered by the shell, the extended part extends out the shell and is bent up or down to fix the conductive bases with the shell.

6. The inductor device of claim 1, wherein each conductive base further comprise one coupling position for receiving a corresponding end of the coil.
